(19) United States
(12) Patent Application Publication
(10) Pub. No.: US 2026/0351259 A1
(43) Pub. Date: Nov. 5, 2026

(54) KNOWLEDGE DISTILLATION FOR CAPITALIZED AND PUNCTUATED END-TO-END SPEECH-TO-TEXT FROM SINGLE-CASE SPEECH-TO-TEXT

(71) Applicant: International Business Machines Corporation, Armonk, NY (US)

(72) Inventors: Sashi Novitasari, Bunkyo (JP); Takashi Fukuda, Tokyo (JP); Gakuto Kurata, Tokyo (JP)

(21) Appl. No.: 19/197,764

(22) Filed: May 2, 2025

(51) Int. Cl. G10L 15/26; G10L 25/24

(52) U.S. Cl. CPC G10L 15/26; G10L 25/24

(57) ABSTRACT

A system includes a processor that executes computer executable components stored in a memory. The computer executable components can comprise a reception component that receives an audio input; a teacher component that utilizes a single-case speech-to-text (STT) model to generate a first transcription output; a student component that utilizes a mixed-case STT model to generate a second transcription output comprising capitalized and punctuated text, and a third transcription output comprising lowercase and unpunctuated text; and a training management component that applies a linear transformation layer to compute the third transcription output during training, computes a knowledge distillation loss, updates parameters of the student component, and removes the linear transformation layer.

### BACKGROUND

The subject disclosure relates to knowledge distillation, e.g., knowledge distillation for capitalized and punctuated end-to-end speech-to-text from single-case speech-to-text.

Automatic speech recognition (ASR) systems have made significant progress in recent years, particularly through the adoption of end-to-end (E2E) architectures. These E2E models simplify the speech-to-text (STT) pipeline by directly mapping acoustic input to transcribed text, often improving computational efficiency and overall latency. However, many widely adopted E2E STT systems output transcriptions in a single-case format—typically lowercase and without punctuation. While suitable for certain applications, such outputs suffer from low readability and limited usability in contexts that demand well-formatted textual content, such as professional communication, legal transcription, or automated captioning.

To enhance the usability of ASR outputs, there has been increasing interest in developing E2E STT systems that generate mixed-cased and punctuated transcriptions directly from speech input. These systems aim to produce outputs that are capitalized and punctuated without relying on separate post-processing modules, which are common in traditional cascaded or two-pass STT pipelines. Eliminating these additional modules offers the potential for reduced inference latency and a more streamlined deployment in real-time applications.

Despite these potential advantages, E2E mixed-cased STT systems currently exhibit notable limitations. In particular, they tend to demonstrate lower overall accuracy compared to their single-case counterparts. E2E systems that natively generate capitalized and punctuated text directly from speech—without relying on separate modules—still underperform compared to single-case STT systems with respect to transcription accuracy.

Thus, there is a need for improved systems that can bridge this performance gap while preserving the benefits of direct mixed-case transcription.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, computer-implemented methods, and/or computer program products that facilitate knowledge distillation for capitalized and punctuated end-to-end speech-to-text from single-case speech-to-text are provided.

According to an embodiment, a system can comprise a processor that executes computer executable components stored in memory. The computer executable components can comprise a reception component that receives an audio input. The computer executable components can further comprise a teacher component that utilizes a single-case speech-to-text (STT) model to generate a first transcription output. The computer executable components can further a student component that utilizes a mixed-case STT model to generate a second transcription output comprising capitalized and punctuated text, and a third transcription output comprising lowercase and unpunctuated text. The computer executable components can further comprise a training management component that applies a linear transformation layer to compute the third transcription output during training, computes a knowledge distillation loss, updates parameters of the student component, and removes the linear transformation layer.

According to another embodiment, a computer-implemented method can comprise receiving, by a system operatively coupled to a processor, an audio input. The computer-implemented method can comprise utilizing, by the system, a single-case speech-to-text (STT) model to generate a first transcription output. The computer-implemented method can further comprise utilizing, by the system, a mixed-case STT model to generate a second transcription output comprising capitalized and punctuated text and a third transcription output comprising lowercase and unpunctuated text. The computer implemented method can further comprise applying, by the system, a linear transformation layer to compute the third transcription output during training. The computer implemented method can further comprise computing, by the system a knowledge distillation loss. The computer implemented method can further comprise updating, by the system, parameters of the mixed-case STT model. The computer implemented method can further comprise removing, by the system, the linear transformation layer, thereby enabling the mixed-case STT model to generate capitalized and punctuated transcriptions.

According to another embodiment, a computer program product can comprise a computer readable storage medium having program instructions embodied therewith. The program instructions can be executable by a processor to cause the processor to receive, by the processor, an audio input. The program instructions can also cause the processor to utilize, by the processor, a single-case speech-to-text (STT) model to generate a first transcription output. The program instructions can also cause the processor to utilize, by the processor, a mixed-case STT model to generate a second transcription output comprising capitalized and punctuated text and a third transcription output comprising lowercase and unpunctuated text. The program instructions can also cause the processor to apply, by the processor, a linear transformation layer to compute the third transcription output during training. The program instructions can further cause the processor to compute, by the processor, a knowledge distillation loss. The program instructions can further cause the processor to update, by the processor, parameters of the mixed-case STT model. The program instructions can further cause the processor to remove, by the processor, the linear transformation layer, thereby enabling the mixed-case STT model to generate capitalized and punctuated transcriptions.

### BRIEF DESCRIPTION OF THE DRAWINGS

FIG. 1 illustrates an example system that can facilitate knowledge distillation for capitalized and punctuated end-to-end speech-to-text from single-case speech-to-text in accordance with some embodiments described herein.

FIG. 2 illustrates a flow diagram of an example computer implemented method that can facilitate knowledge distillation for capitalized and punctuated end-to-end speech-to-text from single-case speech-to-text in accordance with some embodiments described herein.

FIG. 3 illustrates an example architecture for capitalized and punctuated end-to-end speech-to-text (STT) from a single-case speech-to-text model in accordance with some embodiments described herein.

FIG. 4 illustrates results of an example use case demonstrating the effectiveness of knowledge distillation for capitalized and punctuated end-to-end speech-to-text from single-case speech-to-text in accordance with some embodiments described herein.

FIG. 5 illustrates a block diagram of an example computing environment in which some embodiments described herein can be facilitated.

### DETAILED DESCRIPTION

The following detailed description is merely illustrative and is not intended to limit embodiments, applications, and/or uses of embodiments. Furthermore, there is no intention to be bound by any expressed or implied information presented in the preceding Background or Summary sections, or in the Detailed Description section.

End-to-end (E2E) automatic speech recognition (ASR) systems have emerged as a compelling alternative to traditional multi-stage pipelines by directly mapping speech waveforms to text transcriptions using unified neural network architectures. These models can simplify deployment, reduce system complexity, and enable real-time transcription capabilities in a variety of domains. However, conventional E2E speech-to-text (STT) systems typically produce unformatted, single-case transcriptions—e.g., entirely lowercase and devoid of punctuation marks. While such outputs may suffice for certain machine processing tasks, they can be difficult for humans to read and interpret in real-world applications, such as meeting transcription, closed captioning, virtual assistants, and medical or legal documentation.

To address the readability gap, recent research has attempted to produce capitalized and punctuated transcriptions directly from audio input. These systems aim to output well-formed natural language sentences without relying on post-processing modules for text formatting. This E2E mixed-cased STT offers key advantages over cascaded or two-pass systems, such as reduced inference latency, lower engineering complexity, and improved usability for downstream applications. Yet despite these advantages, current E2E mixed-cased STT systems still suffer from performance limitations. Integrating case and punctuation prediction directly into the speech-to-text process increases modeling complexity, which in turn can compromise word recognition accuracy. Empirical observations show that mixed-cased STT models often produce less accurate word content compared to their single-case counterparts. In practice, while these systems may successfully insert capital letters and punctuation marks, they tend to exhibit degraded performance in terms of case- and punctuation-insensitive word error rate (WER), a critical benchmark for STT reliability. Predicting orthographic and grammatical features (e.g., punctuation boundaries and capitalization rules) requires the model to learn more complex linguistic structures, often without sufficient guidance. Single-case STT models, in contrast, benefit from a more constrained prediction space and are thus better able to learn meaningful acoustic and lexical representations for correct word identification.

Recent work has explored auxiliary training strategies to alleviate this issue. Such approaches have shown promise but still rely on the assumption that learning to predict unformatted text from scratch can be trivially extended to mixed-case output, which is often not the case in practice.

The presently disclosed invention addresses this shortfall by introducing a novel knowledge distillation (KD)-based training framework. In this approach, a high-performing single-case STT model—referred to as the teacher—is used to guide the training of a mixed-cased STT model—referred to as the student. The teacher model, which excels at accurate word recognition without regard to formatting, generates intermediate representations or soft targets that encapsulate critical linguistic and acoustic knowledge. The student model, tasked with producing capitalized and punctuated text, is trained not only on ground-truth mixed-case labels but also to align with the output distributions of the teacher model. This enables the student to benefit from the teacher's deep lexical understanding while simultaneously learning orthographic conventions.

This distillation-based approach offers multiple advantages. First, it improves the case- and punctuation-sensitive accuracy of the student model without sacrificing case- and punctuation-insensitive performance. Second, it reduces the risk of word recognition degradation that typically arises when additional tasks (e.g., punctuation prediction) are introduced. Third, it allows for end-to-end training without requiring additional inference-time modules, thereby preserving the latency and simplicity benefits of E2E systems.

In summary, embodiments of the present disclosure can improve the accuracy and usability of E2E mixed-cased STT systems by leveraging the strengths of a single-case STT teacher model in a knowledge distillation framework. These embodiments can enable more human-readable outputs, improve transcription accuracy, and maintain the architectural and deployment advantages of direct speech-to-punctuated-text recognition.

The disclosed invention relates to a system and method that can generate accurate, human-readable transcriptions from speech input by producing capitalized and punctuated text directly, without requiring additional post-processing modules. The system can improve usability in applications where properly formatted text is essential, such as real-time transcription, automated captioning, and speech-driven document generation. By integrating case and punctuation prediction into the core transcription process, the system can produce outputs that are immediately readable and structured, while preserving high word recognition accuracy.

At the core of the system can be a dual-model training architecture involving a teacher model and a student model. The teacher model can be a single-case speech-to-text model that can excel at recognizing the correct words in a spoken utterance, outputting lowercase, unpunctuated transcriptions. The student model can be configured to generate both a capitalized and punctuated transcription, as well as a secondary lowercase and unpunctuated transcription. During training, the student model can be guided by the teacher model through a process of knowledge distillation. The teacher model can provide high-confidence word-level predictions that the student model can be trained to emulate, thereby improving its own transcription accuracy.

The student model can be temporarily augmented during training with a linear transformation layer that enables it to generate the secondary, single-case transcription output. A training management component can compute a knowledge distillation loss by comparing this output to the corresponding output from the teacher model. This distillation loss can be backpropagated through the student model's architecture to update its parameters. By learning from the teacher model's simpler yet accurate word recognition capabilities, the student model can acquire a deeper and more stable representation of lexical content while also learning how to generate proper capitalization and punctuation.

Once training is complete, the system can remove the linear transformation layer, allowing the student model to operate in a streamlined inference mode. In this configuration, the student model can accept an audio input and produce a well-formatted transcription that includes capitalization and punctuation, without requiring separate formatting modules or increased latency. The system architecture can support various model types, including transformer-based or recurrent neural network-based models, and can preprocess the audio input using features such as Mel-frequency cepstral coefficients (MFCCs), spectrograms, or waveform-based representations. Through this architecture, the system can deliver an end-to-end speech recognition solution that combines formatting accuracy with linguistic precision in a highly efficient deployment.

According to an embodiment, a system can include a processor that executes computer executable components stored in memory. The computer executable components can comprise a reception component that receives an audio input. The computer executable components can further comprise a teacher component that utilizes a single-case speech-to-text (STT) model to generate a first transcription output. The computer executable components can further a student component that utilizes a mixed-case STT model to generate a second transcription output comprising capitalized and punctuated text, and a third transcription output comprising lowercase and unpunctuated text. The computer executable components can further comprise a training management component that applies a linear transformation layer to compute the third transcription output during training, computes a knowledge distillation loss, updates parameters of the student component, and removes the linear transformation layer.

In some embodiments, the audio input can further comprise spoken language. The first transcription output can further comprise lowercase or unpunctuated text. In various embodiments, the training management component can compute the knowledge distillation loss based on a comparison between the first transcription output from the teacher component and the third transcription output from the student component. The training management component can update the parameters of the student component by backpropagating the knowledge distillation loss throughout a neural network of the mixed-case STT model. In some embodiments, the training management component can remove the linear transformation layer upon completion of training, enabling the student component to utilize the mixed-case STT model to generate capitalized and punctuated transcriptions without requiring additional post-processing modules. In various embodiments, the training management component can adjust a weight of the knowledge distillation loss. In some embodiments, the reception component can process the audio input by performing feature extraction using Mel-frequency cepstral coefficients (MFCCs), spectrogram analysis, or waveform-based representations. The student component can utilize a transformer-based architecture or a recurrent neural network-based architecture to generate the second transcription output and the third transcription output. In various embodiments, the student component can be trained using Mixed-Case Knowledge Distillation (MC-KD). The student component can receive knowledge from the teacher component through knowledge distillation loss. In some embodiments, the student component can generate the third transcription output based on single-case transcription prediction.

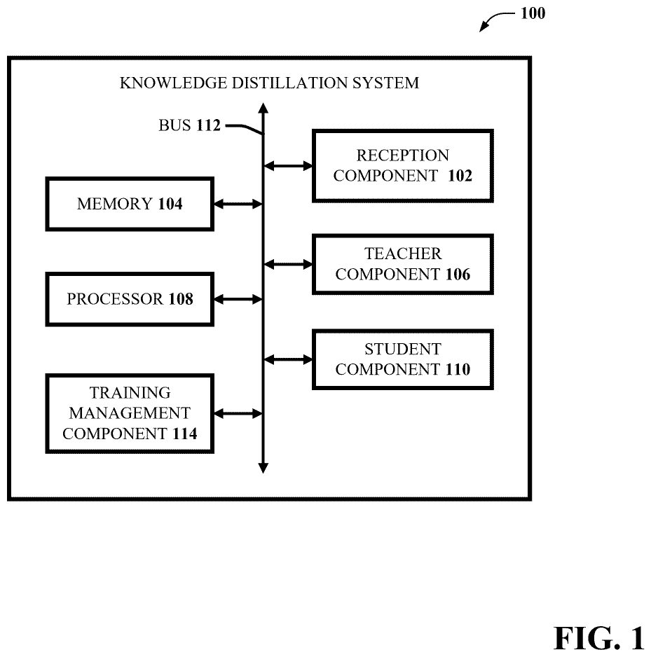

FIG. 1 illustrates an example system 100 for facilitating facilitate knowledge distillation for capitalized and punctuated end-to-end speech-to-text from single-case speech-to-text. The system 100 uses a reception component, a teacher component, a student component, and a training component. reception component can receive an audio input. The teacher component can utilize a single-case speech-to-text (STT) model to generate a first transcription output. The student component can utilize a mixed-case STT model to generate a second transcription output comprising capitalized and punctuated text, and a third transcription output comprising lowercase and unpunctuated text. The training management component can apply a linear transformation layer to compute the third transcription output during training, computes a knowledge distillation loss, updates parameters of the student component, and removes the linear transformation layer.

Aspects of systems (e.g., systems 100, 200, and the like), apparatuses, or processes in various embodiments of the present disclosure can constitute one or more machine-executable components embodied within one or more machines. For example, the components may be embodied in one or more computer readable mediums (or media) associated with one or more machines. Such components, when executed by the one or more machines (e.g., computers, computing devices, virtual machines, etc.) can cause the machines to perform the operations described. System 100 can comprise a reception component 102, a memory 104, a teacher component 106, a processor 108, a student component 110, a system bus 112, and a training component 114.

The system 100 and/or the components of the system 100 may use hardware and/or software to solve problems that are highly technical in nature. The system 100 solves problems that are not abstract and that cannot be performed as a set of mental acts by a human. Further, some of the processes can be performed by specialized computers for carrying out defined tasks related to knowledge distillation for capitalized and punctuated end-to-end speech-to-text from single-case speech-to-text. The system 100 and/or components of the system 100 can be employed to solve new problems that arise through advancements in technologies. The system 100 can provide technical improvements to knowledge distillation for capitalized and punctuated end-to-end speech-to-text from single-case speech-to-text by producing capitalized and punctuated text directly, without requiring additional post-processing modules.

The system 100 can include a processor 108. In some embodiments, the processor 108 can execute a component or subcomponent associated with the system 100. Components or subcomponents associated with the system 100 can include one or more machine readable, writable, and/or executable instructions. In some embodiments, the system 100 can include a memory 104, and the memory 104 can store one or more components and/or subcomponents associated with the system 100. In some embodiments, the processor 108 can execute a component stored in the memory 104.

In some embodiments, the system 100 can include a computer-readable memory 104 that may be operably connected to the processor 108. The memory 104 can store computer-executable instructions that, upon execution by the processor 108, can cause the processor 108 and/or one or more other components of the system 100 (e.g., the reception component 102, the teacher component 106, the student component 110, and/or the training management component 114) to perform one or more actions. In some embodiments, the memory 104 can store computer-executable components (e.g., the reception component 102, the teacher component 106, the student component 110, and/or the training management component 114).

The system 100 and/or a component thereof as described herein can be communicatively, electrically, operatively, optically, and/or otherwise coupled to one another via a bus 112. The bus 112 can include one or more of a memory bus, memory controller, peripheral bus, external bus, local bus, and/or another type of bus that may employ one or more bus architectures. In some embodiments, the system 100 can be coupled (e.g., communicatively, electrically, operatively, optically, and/or the like) to one or more external systems (e.g., an electrical output production system, one or more output targets, an output target controller, and/or the like). In some embodiments, the system 100 can be coupled to one or more external sources, and/or devices (e.g., classical computing devices, communication devices, and/or like devices), such as via a network. In some embodiments, one or more of the components of the system 100 can reside in the cloud and/or locally in a local computing environment (e.g., at one or more specified locations).

In addition to the processor 108 and/or the memory 104 described above, the system 100 can include one or more computer and/or machine readable, writable, and/or executable components and/or instructions. When executed by the processor 108, these components and/or instructions can enable performance of one or more operations defined by the component(s) and/or instruction(s).

In various embodiments, the reception component 102 can receives an audio input. The audio input can comprise spoken language captured from a user, a recording, or another source of speech data. The reception component 102 can perform initial acquisition and preprocessing of the audio signal to facilitate further processing by the system 100. In some embodiments, the reception component 102 can extract relevant features from the audio input to convert the raw waveform data into a structured format suitable for input into downstream components, such as the teacher component 106 and the student component 110. The feature extraction performed by the reception component 102 can include, but is not limited to, Mel-frequency cepstral coefficients (MFCCs), spectrograms, filter banks, or waveform-based embeddings.

In certain implementations, the reception component 102 can normalize or enhance the audio input to improve robustness against noise, volume variations, or other distortions commonly present in real-world speech recordings. The reception component 102 can apply one or more preprocessing techniques, such as amplitude normalization, noise reduction, silence trimming, or dynamic range compression. These preprocessing operations can help ensure that the extracted speech features are clean and consistent, thereby enabling higher transcription accuracy by the teacher component 106 and student component 110. Additionally, the reception component 102 can perform segmentation of continuous speech into manageable chunks or frames to optimize processing throughput and facilitate batch-wise processing within the system 100.

In some embodiments, the reception component 102 can be further configured to interface with external audio sources or networked devices. For instance, the reception component 102 can receive streaming audio data over a network connection, capture live microphone input from a user device, or ingest pre-recorded audio files from a storage medium. The reception component 102 can operate synchronously or asynchronously, depending on system configuration requirements, and can buffer, queue, or stream the audio features to other components for parallel or sequential processing.

In some embodiments, the reception component 102 can preprocess the audio input by performing feature extraction operations. The feature extraction can include generating Mel-frequency cepstral coefficients (MFCCs), conducting spectrogram analysis, or utilizing waveform-based representations. The reception component 102 can convert the raw audio waveform into a compact and information-rich feature set that can preserve essential acoustic characteristics relevant for speech recognition. For example, the reception component 102 can compute MFCCs to model the perceptual characteristics of human hearing, perform spectrogram analysis to capture time-frequency distributions of energy in the speech signal, or directly use waveform representations enhanced by normalization or filtering techniques.

According to some embodiments, the teacher component 106 can utilize a single-case speech-to-text (STT) model to generate a first transcription output. The single-case STT model can be configured to produce transcriptions that consist of lowercase text and lack punctuation, thereby focusing solely on accurate word recognition without the additional complexity of formatting. The teacher component 106 can receive preprocessed audio features from the reception component 102 and can process these features through a sequence of neural network layers, which can include convolutional layers, recurrent layers, Conformer blocks, transformer encoders, or other suitable architectures. By generating a first transcription output comprising lowercase and unpunctuated text, the teacher component 106 can serve as a high-accuracy supervisory signal during training of the student component 110. The teacher component 106 can provide outputs that are case- and punctuation-insensitive, enabling the system 100 to transfer lexical knowledge effectively to the mixed-case student model during the knowledge distillation process.

According to some embodiments, the student component 110 can utilize a mixed-case speech-to-text (STT) model to generate transcription outputs from received audio input. The student component 110 can generate a second transcription output comprising capitalized and punctuated text, providing a human-readable format suitable for direct use in applications such as captioning, documentation, or virtual assistants. In addition, during training, the student component 110 can also generate a third transcription output comprising lowercase and unpunctuated text. This third output can serve as an auxiliary output aligned with the output style of the teacher component 106, supporting effective transfer of word-level recognition knowledge through knowledge distillation.

The student component 110 can be implemented using a transformer-based architecture, a recurrent neural network (RNN)-based architecture, or a combination thereof. In some embodiments, the student component 110 can include Conformer blocks, LSTM layers, GRU layers, or attention-based modules to process the preprocessed audio features into transcriptions. The architecture can be designed to output both the mixed-case (capitalized and punctuated) transcription and the auxiliary single-case transcription simultaneously during training. To support generation of the auxiliary output, the student component 110 can be augmented during training with a temporary linear transformation layer placed above the main mixed-case output layer. This configuration can enable the student component 110 to efficiently produce predictions suitable for both case-sensitive and case-insensitive supervision.

The student component 110 can be trained using a Mixed-Case Knowledge Distillation (MC-KD) framework. Under this framework, the student component 110 can receive knowledge from the teacher component 106 through the application of a knowledge distillation loss. This loss can be computed based on a comparison between the student's third transcription output and the teacher's first transcription output. The knowledge distillation loss can guide the student component 110 to learn meaningful internal representations that preserve accurate word recognition while simultaneously learning case and punctuation formatting through the primary task. By generating the third transcription output based on single-case transcription prediction, the student component 110 can benefit from the strengths of the simpler teacher model while extending its capabilities to produce formatted text directly. After training is completed, the auxiliary output pathway and the associated linear transformation layer can be removed, enabling the student component 110 to operate in a streamlined inference mode that produces only the mixed-case output without additional complexity or latency.

According to some embodiments, the training management component 114 can apply a linear transformation layer to the student component 110 during training. This linear transformation layer can be configured to project the internal representations of the student component 110 into a secondary output space corresponding to single-case transcription prediction. By inserting this additional layer, the training management component 114 can enable the student component 110 to generate the third transcription output, comprising lowercase and unpunctuated text, alongside the primary mixed-case output. The training management component 114 can supervise this auxiliary output as part of a multi-task training strategy, which can strengthen the student model's internal representations and enhance word recognition capabilities.

The training management component 114 can compute a knowledge distillation loss based on a comparison between the first transcription output generated by the teacher component 106 and the third transcription output generated by the student component 110. In some embodiments, the knowledge distillation loss can be computed using mean squared error (MSE) loss, Kullback-Leibler (KL) divergence, or another suitable loss function designed to align the student's auxiliary predictions with the teacher's outputs. By minimizing this knowledge distillation loss, the training management component 114 can encourage the student component 110 to mimic the lexical prediction behavior of the teacher component 106, thereby transferring the teacher's superior word recognition performance into the mixed-case student model.

The training management component 114 can update the parameters of the student component 110 by backpropagating the knowledge distillation loss through the neural network layers of the mixed-case STT model. In some embodiments, the training management component 114 can also combine the knowledge distillation loss with other loss terms, such as case- and punctuation-sensitive CTC loss or case- and punctuation-insensitive CTC loss, applying weighting coefficients to control the relative contributions of each loss term during optimization. Upon completion of training, the training management component 114 can remove the linear transformation layer that was used to generate the auxiliary output. This removal can streamline the student component 110 for inference, enabling the student model to generate only capitalized and punctuated transcriptions without incurring additional inference-time computational overhead or requiring separate post-processing modules. Furthermore, the training management component 114 can dynamically adjust a weight of the knowledge distillation loss during training to balance the emphasis between teacher supervision and direct mixed-case label supervision, providing fine-grained control over the learning process to achieve optimal transcription accuracy.

The systems and/or devices are described herein with respect to interaction between one or more components. Such systems and/or components may include the components and/or sub-components specified therein, one or more of the specified components and/or sub-components, and/or additional components. Sub-components may be implemented as components communicatively coupled to other components rather than included within parent components. One or more components and/or sub-components may be combined into a single component providing aggregate functionality. The components may interact with one or more other components not specifically described herein for the sake of brevity but known by those of skill in the art.

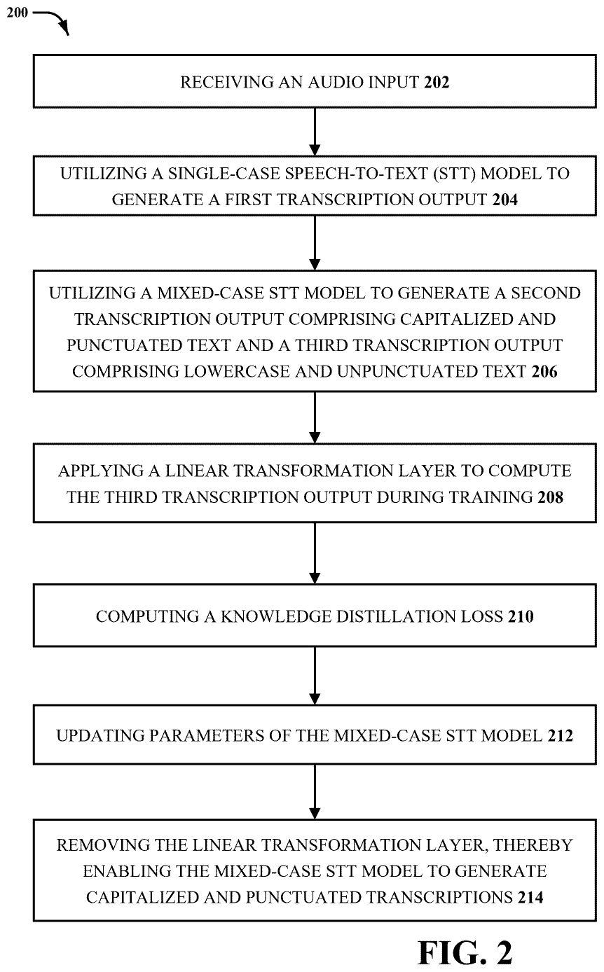

FIG. 2 illustrates an example a flow diagram of an example computer implemented method that can facilitate knowledge distillation for capitalized and punctuated end-to-end speech-to-text from single-case speech-to-text in accordance with some embodiments described herein.

The flow diagram 200 starts by receiving 202 an audio input. At block 202, the method can include receiving an audio input. The audio input can comprise speech data captured from one or more sources, such as microphones, telecommunication devices, cloud-based voice services, or embedded audio sensors. The system can receive the audio input in a variety of formats, including but not limited to raw waveform data, compressed audio streams, or preprocessed acoustic feature representations. In some embodiments, the system can preprocess the received audio input by applying feature extraction techniques, such as Mel-frequency cepstral coefficients (MFCCs), spectrogram analysis, or waveform normalization, to generate features suitable for processing by the speech-to-text models. The reception of the audio input can occur in real-time or can be performed on pre-recorded datasets, depending on the specific deployment or training scenario.

The flow diagram 200 continues by utilizing 204 a single-case speech-to-text (STT) model to generate a first transcription output. At block 204, the method can include utilizing a single-case speech-to-text (STT) model to generate a first transcription output. The single-case STT model can be configured to process the audio input or its preprocessed feature representation to produce a transcription comprising lowercase and unpunctuated text. The single-case model can include architectures such as transformer-based models, recurrent neural networks, or Conformer-based models optimized for accurate word recognition without the additional complexity of formatting prediction. In some embodiments, the single-case STT model can generate a probability distribution over a vocabulary consisting of lowercase characters and basic symbols, followed by decoding to produce the first transcription output. The first transcription output can serve as a high-accuracy supervisory signal, enabling the system to guide the training of a mixed-case student model through knowledge distillation.

The flow diagram 200 continues by utilizing 206 a mixed-case STT model to generate a second transcription output comprising capitalized and punctuated text and a third transcription output comprising lowercase and unpunctuated text. At block 206, the method can include utilizing a mixed-case speech-to-text (STT) model to generate a second transcription output comprising capitalized and punctuated text and a third transcription output comprising lowercase and unpunctuated text. The mixed-case STT model can process the audio input or its preprocessed feature representation through a series of neural network layers, which can include transformer layers, recurrent layers, Conformer blocks, or combinations thereof. The second transcription output can be generated by projecting the model's internal representations into a vocabulary that includes both uppercase and lowercase characters, as well as punctuation symbols, thereby enabling the direct production of human-readable, well-formatted text. In parallel, during training, the mixed-case STT model can generate a third transcription output via a temporary linear transformation layer, producing a lowercase and unpunctuated version of the transcription. The third transcription output can be aligned with the style of the single-case STT model, enabling effective application of knowledge distillation techniques. By simultaneously generating both outputs, the mixed-case STT model can be trained to recognize lexical content with high accuracy while learning capitalization and punctuation formatting in an integrated, end-to-end manner.

The flow diagram 200 continues by applying 208 a linear transformation layer to compute the third transcription output during training. At block 208, the method can include applying a linear transformation layer to compute the third transcription output during training. The linear transformation layer can be temporarily added on top of the internal representation output by the mixed-case STT model. This transformation layer can project the higher-dimensional mixed-case output space into a lower-dimensional space corresponding to single-case transcription, which includes only lowercase characters and basic symbols. The linear transformation layer can enable the model to efficiently generate the third transcription output aligned with the format of the single-case teacher model. In some embodiments, the application of the linear transformation layer can allow the auxiliary single-case output to be trained jointly with the main mixed-case transcription output, facilitating multi-task learning. The temporary transformation can be fully integrated into the training pipeline, allowing loss signals derived from the third transcription output to backpropagate through the entire mixed-case STT model, thereby improving both lexical recognition and formatting capabilities during model optimization.

The flow diagram 200 continues by computing 210 a knowledge distillation loss. At block 210, the method can include computing a knowledge distillation loss. The knowledge distillation loss can be computed based on a comparison between the first transcription output generated by the teacher component and the third transcription output generated by the student component. In some embodiments, the knowledge distillation loss can be calculated using mean squared error (MSE) loss, Kullback-Leibler (KL) divergence, or another appropriate divergence metric to measure the similarity between the teacher's and student's output distributions. The knowledge distillation loss can guide the student model to align its single-case transcription predictions with those of the highly accurate teacher model, thereby enabling the transfer of lexical knowledge from the teacher model to the student model.

The flow diagram 200 continues by updating 212 parameters of the mixed-case STT model. At block 212, the method can include updating parameters of the mixed-case STT model. The parameters of the mixed-case STT model can be updated by backpropagating the knowledge distillation loss, along with any other computed loss terms, throughout the neural network layers of the student component. In some embodiments, the update process can involve computing gradients with respect to the loss function and applying an optimization algorithm, such as stochastic gradient descent (SGD), Adam, or a variant thereof, to adjust the model's weights. The updates can simultaneously improve the student model's ability to accurately predict lexical content in a case- and punctuation-insensitive manner, while also enhancing its ability to generate capitalized and punctuated text. Through this iterative parameter update process, the mixed-case STT model can progressively learn to integrate knowledge from both the gold labels and the teacher model, thereby improving both case-insensitive and case-sensitive transcription performance.

The flow diagram 200 continues by removing 214 the linear transformation layer, thereby enabling the mixed-case STT model to generate capitalized and punctuated transcriptions. At block 214, the method can include removing the linear transformation layer, thereby enabling the mixed-case STT model to generate capitalized and punctuated transcriptions. Upon completion of training, the temporary linear transformation layer used to compute the auxiliary single-case transcription output can be deleted from the model architecture. The removal of the linear transformation layer can streamline the inference pathway of the student component, allowing it to focus solely on generating the second transcription output comprising capitalized and punctuated text. In some embodiments, the mixed-case STT model can operate without any additional auxiliary outputs or post-processing steps, enabling efficient, real-time generation of human-readable transcriptions directly from speech input. By removing the auxiliary training structures after training is complete, the system can preserve the benefits of the multi-task learning strategy without introducing unnecessary inference-time complexity or latency.

In some embodiments, the method 200 can further include preprocessing the audio input prior to generating transcription outputs. The preprocessing can include performing feature extraction operations such as generating Mel-frequency cepstral coefficients (MFCCs), conducting spectrogram analysis, or utilizing waveform-based representations. The method 200 can apply one or more of these feature extraction techniques at or before block 202 to transform the raw audio input into feature representations that preserve important acoustic information while reducing noise and irrelevant variations. By performing preprocessing, the method 200 can enhance the quality and consistency of the input features provided for generating the first transcription output at block 204, the second transcription output at block 206, and the third transcription output at block 206, thereby facilitating improved speech recognition accuracy and more effective training during knowledge distillation.

In some embodiments, the method 200 can further include utilizing a transformer-based architecture or a recurrent neural network (RNN)-based architecture within the mixed-case speech-to-text model to generate both the second transcription output and the third transcription output. At block 206, the method 200 can use a neural network architecture that includes transformer encoder layers, Conformer blocks, LSTM layers, GRU layers, or other suitable recurrent or attention-based modules capable of modeling temporal and contextual patterns in the speech input. Such an architecture can enable the generation of the capitalized and punctuated second transcription output and the lowercase and unpunctuated third transcription output during training.

In some embodiments, the method 200 can further include generating the third transcription output based on single-case transcription prediction. During block 206, the method 200 can apply a linear transformation layer, as described at block 208, to project internal representations into a single-case output space comprising lowercase characters and basic symbols without punctuation. The third transcription output can be produced with the objective of aligning with the style of the first transcription output generated at block 204.

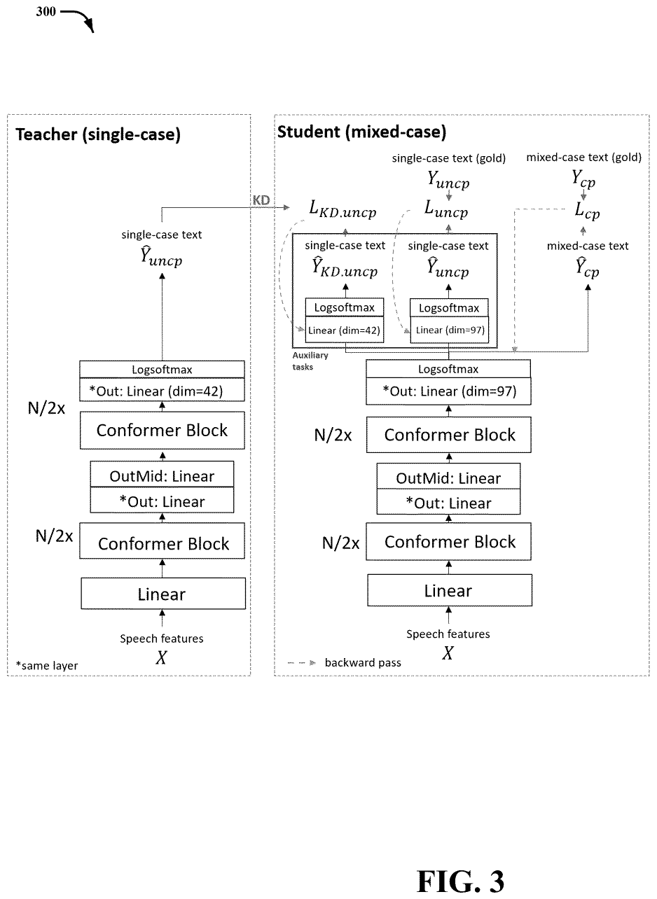

Next, FIG. 3 illustrates an example architecture for capitalized and punctuated end-to-end speech-to-text (STT) from a single-case speech-to-text model.

The system can include a teacher model and a student model. The teacher model can be a single-case speech-to-text (STT) model configured to generate uncapitalized and unpunctuated text output. The student model can be a mixed-case STT model configured to produce both mixed-case and single-case transcription outputs during training.

The teacher model can receive speech features X and process them through a sequence of layers, including a linear layer, one or more Conformer blocks, and a final linear output layer. The teacher's output layer can project to a vocabulary space of size 42, representing lowercase characters and symbols. The output can be passed through a log-softmax function to generate the teacher's single-case prediction Ŷ_{uncp}, which can serve as a knowledge source during training.

The student model can receive the same speech features X and process them through a similar architecture, including linear layers and Conformer blocks. The main output of the student model can be projected to a vocabulary of size 97 (to support capital letters and punctuation) and passed through a log-softmax function to yield a mixed-case transcription prediction Ŷ_{cp}. This mixed-case output can be trained using a case- and punctuation-sensitive loss L_{cp} computed against the gold mixed-case text Y_{cp}.

In addition to its primary output, the student model can be augmented with auxiliary components during training. A secondary linear projection layer (dimension 42) can be temporarily added to the final representation layer, producing an auxiliary single-case prediction Ŷ_{KD.uncp}. This prediction can be supervised in two ways: (1) by computing a CTC loss L_{uncp} against the gold single-case text Y_{uncp}, and (2) by computing a mean squared error (MSE) knowledge distillation loss L_{KD.uncp} against the teacher's prediction Ŷ_{uncp}. The overall student training objective can be represented as: L_{student}=L_{cp}+αL_{uncp}+βL_{KD}, where α and β can be tunable coefficients controlling the influence of the auxiliary tasks. The auxiliary losses can backpropagate through the entirety of the student network, reinforcing consistent internal representations. Upon completion of training, the auxiliary linear transformation layer can be removed, enabling the student model to generate capitalized and punctuated transcriptions directly from speech input in a single forward pass. This architecture can provide enhanced transcription readability without sacrificing word recognition accuracy or introducing additional inference-time complexity.

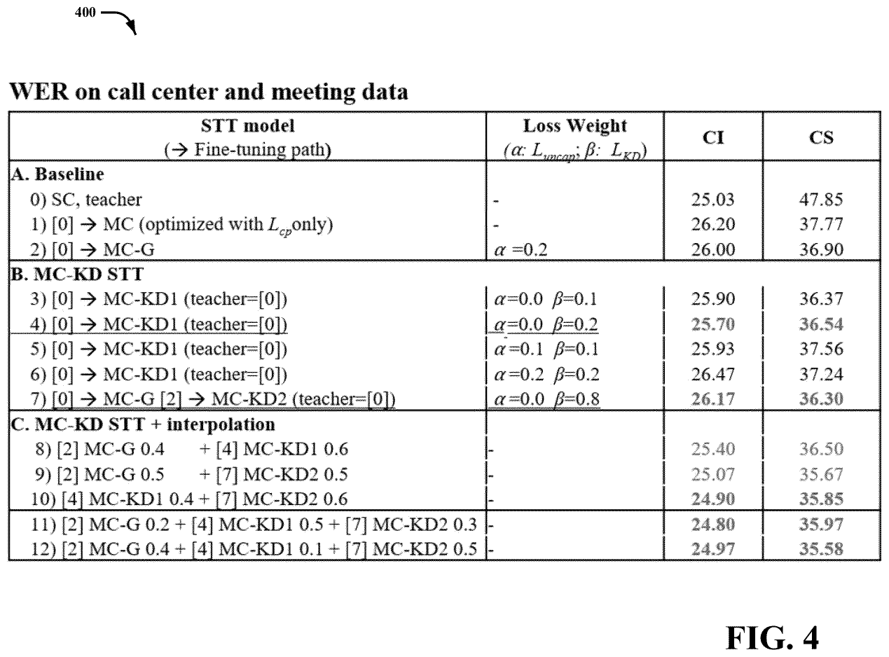

Next, FIG. 4 illustrates results of an example use case demonstrating the effectiveness of knowledge distillation for capitalized and punctuated end-to-end speech-to-text from single-case speech-to-text in accordance with some embodiments described herein. The results shown in FIG. 4 indicate that while the standard mixed-case STT trained only with case-sensitive loss (MC) model improves case- and punctuation-sensitive word error rate (CS WER) compared to the standard single-task single-case STT (SC) model, it results in a degradation of case- and punctuation-insensitive word error rate (CI WER). The multi-task mixed-case model trained with auxiliary and main losses based on gold labels without knowledge distillation (MC-G) can improve CI WER relative to MC by introducing auxiliary tasks. Notably, the proposed MC-KD1 model (that utilize knowledge distillation) can outperform both MC and MC-G in both CI and CS WER, demonstrating the benefit of integrating the teacher model's guidance via knowledge distillation. Furthermore, MC-KD2, which involves two-step tuning, can reduce CS WER even further while maintaining CI WER in a desirable range—striking a strong balance between readability and core recognition accuracy. In some embodiments, interpolation between student outputs and teacher predictions can yield further improvements, achieving the lowest CI and CS WER among all evaluated configurations. These results confirm that the disclosed knowledge distillation-based training strategy can provide significant performance gains for mixed-case STT systems in real-world deployment settings.

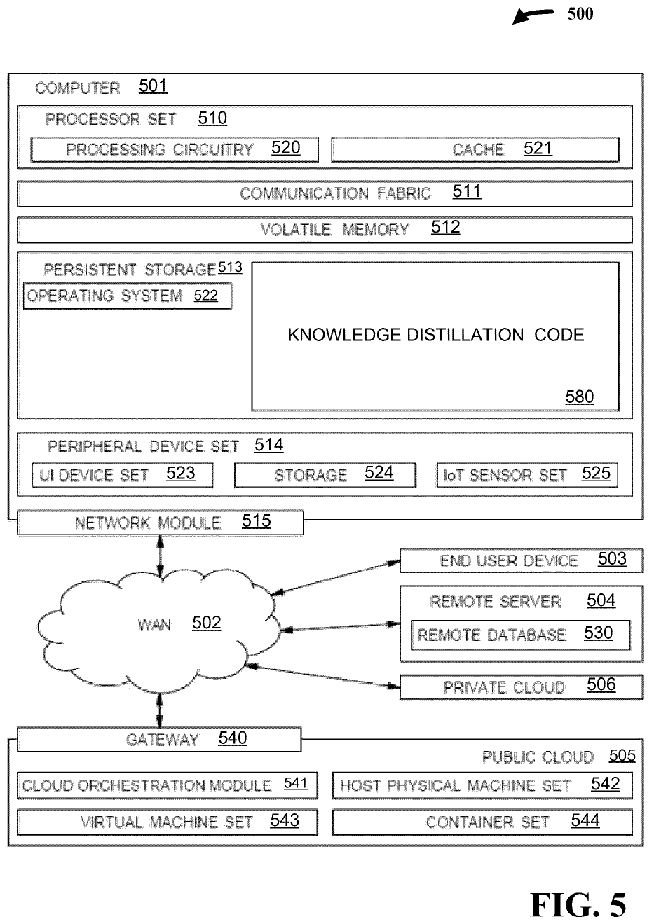

FIG. 5 and the following discussion are intended to provide a brief, general description of a suitable computing environment 500 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code involved in performing the inventive methods, such as iteratively updating the preliminary recovery plan until a failure-free recovery plan is developed with knowledge distillation code 580. In addition to block 580, computing environment 500 includes, for example, computer 501, wide area network (WAN) 502, end user device (EUD) 503, remote server 504, public cloud 505, and private cloud 506. In this embodiment, computer 501 includes processor set 514 (including processing circuitry 520 and cache 521), communication fabric 511, volatile memory 512, persistent storage 513 (including operating system 522 and block 545, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method can be distributed among multiple computers and/or between multiple locations. On the other hand, in this presentation of computing environment 500, detailed discussion is focused on a single computer, specifically computer 501, to keep the presentation as simple as possible. Computer 501 can be located in a cloud, even though it is not shown in a cloud in FIG. 5. On the other hand, computer 501 is not required to be in a cloud except to any extent as can be affirmatively indicated.

PROCESSOR SET 510 includes one, or more, computer processors of any type now known or to be developed in the future. Processing circuitry 520 can be distributed over multiple packages, for example, multiple, coordinated integrated circuit chips. Processing circuitry 520 can implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set can be located “off chip.” In some computing environments, processor set 510 can be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods can be stored in block 545 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory can be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 can be a read only memory (ROM), but typically at least a portion of the persistent storage allows writing of data, deletion of data and re-writing of data. Some familiar forms of persistent storage include magnetic disks and solid-state storage devices. Operating system 522 can take several forms, such as various known proprietary operating systems or open-source Portable Operating System Interface type operating systems that employ a kernel. The code included in block 545 typically includes at least some of the computer code involved in performing the inventive methods.

PERIPHERAL DEVICE SET 514 includes the set of peripheral devices of computer 501. Data communication connections between the peripheral devices and the other components of computer 501 can be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 523 can include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 can be persistent and/or volatile. In some embodiments, storage 524 can take the form of a quantum computing storage device for storing data in the form of qubits. In embodiments where computer 501 is required to have a large amount of storage (for example, where computer 501 locally stores and manages a large database) then this storage can be provided by peripheral storage devices designed for storing large amounts of data, such as a storage area network (SAN) that is shared by multiple, geographically distributed computers. IoT sensor set 525 is made up of sensors that can be used in Internet of Things applications. For example, one sensor can be a thermometer, and another sensor can be a motion detector.

NETWORK MODULE 515 is the collection of computer software, hardware, and firmware that allows computer 501 to communicate with other computers through WAN 502. Network module 515 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501) and can take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 can be a client device, such as thin client, heavy client, mainframe computer and/or desktop computer.

REMOTE SERVER 504 is any computer system that serves at least some data and/or functionality to computer 501. Remote server 504 can be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data can be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs can be stored as images and can be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware and firmware allowing public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1175 and private cloud 1176 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of some of the embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to some embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer executable components stored in memory, wherein the computer executable components comprise:
a reception component that receives an audio input;
a teacher component that utilizes a single-case speech-to-text (STT) model to generate a first transcription output;
a student component that utilizes a mixed-case STT model to generate a second transcription output comprising capitalized and punctuated text, and a third transcription output comprising lowercase and unpunctuated text; and
a training management component that applies a linear transformation layer to compute the third transcription output during training, computes a knowledge distillation loss, updates parameters of the student component, and removes the linear transformation layer.

2. The system of claim 1, wherein the audio input further comprises spoken language.

3. The system of claim 1, wherein the first transcription output further comprises lowercase or unpunctuated text.

4. The system of claim 1, wherein the training management component computes the knowledge distillation loss based on a comparison between the first transcription output from the teacher component and the third transcription output from the student component.

5. The system of claim 1, wherein the training management component updates the parameters of the student component by backpropagating the knowledge distillation loss throughout a neural network of the mixed-case STT model.

6. The system of claim 1, wherein the training management component removes the linear transformation layer upon completion of training, enabling the student component to utilize the mixed-case STT model to generate capitalized and punctuated transcriptions without requiring additional post-processing modules.

7. The system of claim 1, wherein the training management component adjusts a weight of the knowledge distillation loss.

8. The system of claim 1, wherein the reception component preprocesses the audio input by performing feature extraction using Mel-frequency cepstral coefficients (MFCCs), spectrogram analysis, or waveform-based representations.

9. The system of claim 1, wherein the student component utilizes a transformer-based architecture or a recurrent neural network-based architecture to generate the second transcription output and the third transcription output.

10. The system of claim 1, wherein the student component is trained using Mixed-Case Knowledge Distillation (MC-KD).

11. The system of claim 10, wherein the student component receives knowledge from the teacher component through knowledge distillation loss.

12. The system of claim 1, wherein the student component generates the third transcription output based on single-case transcription prediction.

13. A computer-implemented method that utilizes a processor that executes computer executable components stored in memory to perform the following acts:
receiving an audio input;
utilizing a single-case speech-to-text (STT) model to generate a first transcription output;
utilizing a mixed-case STT model to generate a second transcription output comprising capitalized and punctuated text and a third transcription output comprising lowercase and unpunctuated text;
applying a linear transformation layer to compute the third transcription output during training;
computing a knowledge distillation loss;
updating parameters of the mixed-case STT model; and
removing the linear transformation layer, thereby enabling the mixed-case STT model to generate capitalized and punctuated transcriptions.

14. The method of claim 13, wherein the audio input further comprises spoken language.

15. The method of claim 13, wherein the first transcription output further comprises lowercase or unpunctuated text.

16. The method of claim 13, wherein the computing the knowledge distillation loss is further based on a comparison between the first transcription output and the third transcription output.

17. The method of claim 13, further comprising preprocessing the audio input by performing feature extraction using Mel-frequency cepstral coefficients (MFCCs), spectrogram analysis, or waveform-based representations.

18. The method of claim 13, further comprising utilizing a transformer-based architecture or a recurrent neural network-based architecture to generate the second transcription output and the third transcription output.

19. The method of claim 13, wherein the generating the third transcription output is based on single-case transcription prediction.

20. A computer program product comprising a computer readable storage medium having program instructions embodied therewith, the program instructions executable by a processor to cause the processor to:
receive an audio input;
utilize a single-case speech-to-text (STT) model to generate a first transcription output;
utilize a mixed-case STT model to generate a second transcription output comprising capitalized and punctuated text and a third transcription output comprising lowercase and unpunctuated text;
apply a linear transformation layer to compute the third transcription output during training;
compute a knowledge distillation loss;
update parameters of the mixed-case STT model; and
remove the linear transformation layer, thereby enabling the mixed-case STT model to generate capitalized and punctuated transcriptions.
